(19) United States
(12) Patent Application Publication
(10) Pub. No.: US 2025/0282146 A1
(43) Pub. Date: Sep. 11, 2025

(54) RECORDING APPARATUS AND METHOD OF CONTROLLING THE SAME

(71) Applicant: CANON KABUSHIKI KAISHA, Tokyo (JP)

(72) Inventor: KOICHI FUKUTAKI, Kanagawa (JP)

(21) Appl. No.: 19/065,918

(22) Filed: Feb. 27, 2025

(30) Foreign Application Priority Data
Mar. 7, 2024 (JP) 2024-035180

(51) Int. Cl. B41J 2/175; B41J 2/20; B41J 3/46; B41J 29/46

(52) U.S. Cl. CPC B41J 2/17566; B41J 2/20; B41J 3/46; B41J 29/46

(57) ABSTRACT

A recording apparatus includes a holder including a plurality of tanks that contains liquid, a recording head that ejects the liquid supplied from the plurality of tanks, and a control unit that provides a notification about an instruction for agitating the liquid in two or more tanks of the plurality of tanks.

### BACKGROUND

### Field

The present disclosure relates to a recording apparatus and a method of controlling the recording apparatus.

### Description of the Related Art

Japanese Patent Application Laid-Open No. 2012-45891 discloses an ink-jet recording apparatus including ink tanks and a stirring unit for stirring ink in the ink tank. The ink-jet recording apparatus also includes a calculation unit for measuring an elapsed time since a last stirring operation and an acquisition unit for acquiring the amount of ink consumed since the last stirring operation, and determines whether to perform a stirring operation based on both the elapsed time and the amount of ink consumed since the previous stirring operation. The method discloses an efficient execution of an ink stirring operation at an appropriate timing.

However, in the configuration according to Japanese Patent Application Laid-Open No. 2012-45891, if a user manually agitates ink in an ink tank without a stirring unit in an ink-jet recording apparatus, instructions for inefficient agitation to the user can be issued.

### SUMMARY

The present disclosure has been made in light of the above-described issue, and is directed to providing a recording apparatus that instructs efficient operations.

According to an aspect of the present disclosure, a recording apparatus comprises a holder including a plurality of tanks configured to contain liquid, a recording head configured to eject the liquid supplied from the plurality of tanks, and a control unit configured to provide a notification about an instruction for agitating the liquid in two or more tanks of the plurality of tanks.

Further features of the present disclosure will become apparent from the following description of exemplary embodiments with reference to the attached drawings.

### BRIEF DESCRIPTION OF THE DRAWINGS

FIG. 1 is a block diagram illustrating a system configuration of a recording apparatus according to a first exemplary embodiment.

FIG. 2 is a block diagram illustrating a configuration of a supply control unit of the recording apparatus according to the first exemplary embodiment.

FIG. 3 is a block diagram illustrating a configuration of a control unit of the recording apparatus according to the first exemplary embodiment.

FIG. 4 is a diagram illustrating processing of adjusting an agitation timing of the recording apparatus according to the first exemplary embodiment.

FIG. 5 is a flowchart illustrating the processing of adjusting the agitation timing of the recording apparatus according to the first exemplary embodiment.

FIG. 6 is a flowchart illustrating processing of adjusting an agitation timing of a recording apparatus according to a second exemplary embodiment.

FIG. 7 is a diagram illustrating an example of a display screen of the recording apparatus according to the first exemplary embodiment.

FIG. 8 is a view illustrating a configuration of the recording apparatus according to the first exemplary embodiment.

### DESCRIPTION OF THE EMBODIMENTS

Some exemplary embodiments of the present disclosure will now be described with reference to the drawings. The following exemplary embodiments do not limit the present disclosure, and all of the combinations of features described in the exemplary embodiments are used for the solutions provided by the present disclosure. Relative arrangements and shapes of constituent elements described in the exemplary embodiments are merely examples, and not intended to limit the scope of the present disclosure.

“Recording” refers to a case of forming information, such as characters, graphic patterns, an image, a design, or a pattern on a recording medium, or a case of performing a process on a medium. A subject to be recorded is not limited to what is visually perceivable by a human. It is also assumed that a “document” or a “recording medium” is a paper sheet in the present exemplary embodiments, but the document or the recording medium may be a cloth, a plastic film, etc.

“Ink” (which may be referred to as “liquid”) is to be construed in a broad sense. Thus, ink represents liquid that is applied to the recording medium and can be supplied to form an image, a design, or a pattern, to perform a process on the recording medium, or to perform ink processing (for example, coagulation or insolubilization of a coloring material in ink).

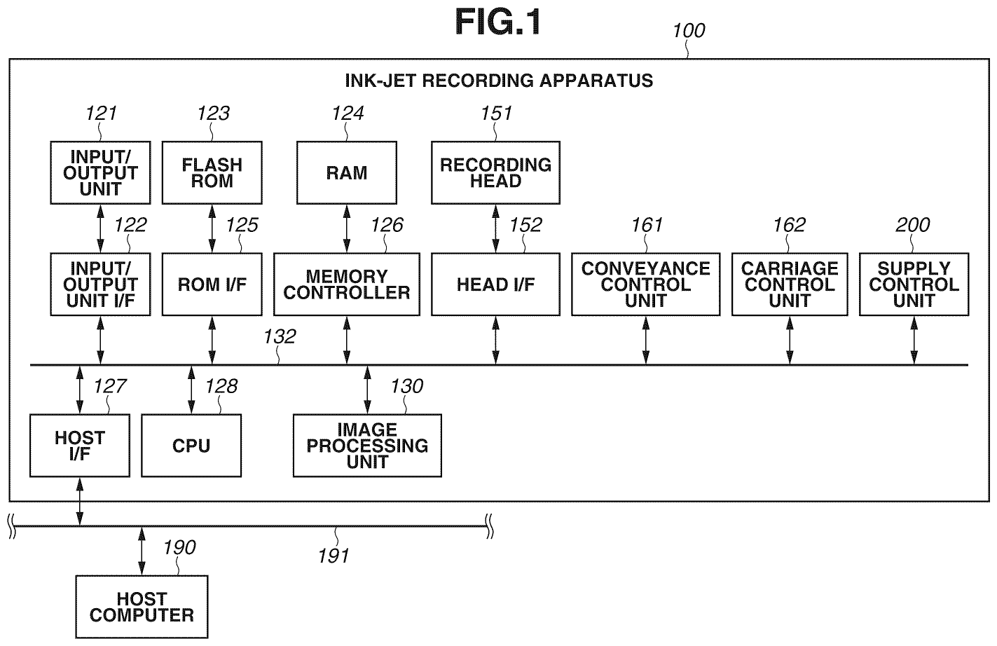

A first exemplary embodiment will now be described. FIG. 1 is a block diagram illustrating a system configuration of an ink-jet recording apparatus according to the present exemplary embodiment. In the present exemplary embodiment, the ink-jet recording apparatus is described as an ink-jet recording apparatus having a print function alone, but is not limited thereto. For example, the ink-jet recording apparatus can be an ink-jet recording apparatus including a reading unit that reads document images and functions as a copy machine, or a multi-function peripheral (MFP) having other functions, such as a function of a fax machine.

An ink-jet recording apparatus 100 (hereinafter referred to as a recording apparatus 100) can be connected to a host computer 190 via a network 191. The recording apparatus 100 includes an input/output unit interface (I/F) 122, a read-only memory (ROM), a ROM I/F 125, a memory controller 126, a host I/F 127, a central processing unit (CPU) 128, and an image processing unit 130. These components are connected to each other via a system bus 132. The recording apparatus 100 also includes a flash ROM 123 and a random-access memory (RAM) 124, which are connected to the system bus 132 via the ROM I/F 125 and the memory controller 126.

The CPU 128 is a central processing unit in a form of a microprocessor (microcomputer), and controls the operations of the recording apparatus 100 via execution of programs or activation of hardware. Various kinds of data for programs to be executed by the CPU 128 and various kinds of operations of the recording apparatus 100 are stored in the flash ROM 123. The RAM 124 is used as a working area of the CPU 128, used as a temporary storage area for various kinds of received data, and stores various kinds of setting data.

The image processing unit 130 performs various kinds of image processing, for example, processing of developing (converting) print data for the recording apparatus 100 (e.g., data represented in a page description language) into image data (bit map image data) and other image processing. The image processing unit 130 converts a color space of image data (for example, YCbCr) included in the input print data into a standard RGB color space (for example, sRGB). The image processing unit 130 also performs, on the image data, various kinds of image processing, such as parsing, resolution conversion into an effective pixel count (that can be subjected to print processing by the recording apparatus 100), image analysis, and image correction as appropriate. The image data obtained by the image processing is stored in the RAM 124.

An input/output unit 121 includes hardware keys and a panel for a user to perform various kinds of operations, such as print settings, and a display unit for displaying (notifying) various kinds of information to the user. The print settings described here include settings for activating/deactivating a manual cut, which will be described below. The input/output unit 121 is controlled by the CPU 128 via the input/output unit I/F 122. The input/output unit 121 can provide information to the user by outputting sound (buzzer sound, or voice) based on sound information from a sound generator.

In the present exemplary embodiment, the input/output unit 121 is located in the recording apparatus 100, but the configuration is not limited thereto, and the input/output unit 121 can be connected to the recording apparatus 100 via the network 191 as an external configuration.

The host computer 190 can also serve as the input/output unit 121. In addition to the input/output unit 121, another input/output unit can be further connectable to the recording apparatus 100 via the network 191.

The host computer 190 is, for example, an external device that serves as a supply source of print data, and there is a case where a printer driver is installed in the host computer 190. In place of the host computer 190, the recording apparatus 100 can be provided with, for example, a data provision apparatus that serves as a supply source of print data, such as a reader for reading an image, a digital camera, or a smartphone.

The host I/F 127 receives print data through stream communication performed by the host computer 190, and the supplied print data is stored in the RAM 124 via the memory controller 126. A connection mode between the external device(s) and the recording apparatus 100 is not limited to a connection via the network 191, and can be a direct connection through, for example, wireless communication.

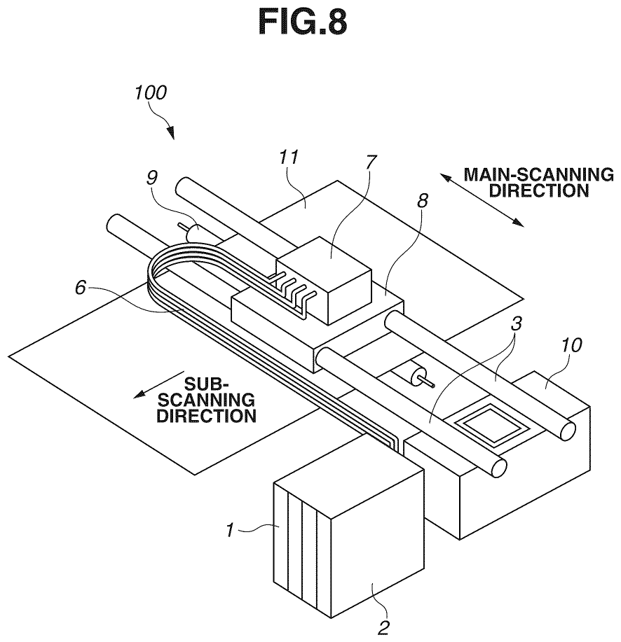

The recording apparatus 100 includes a recording head 151, which is connected to the system bus 132 via a head I/F 152. The recording head 151 is controlled by the CPU 128 via the head I/F 152, and forms images on sheets based on image data. The recording head 151 ejects ink in synchronization with the conveyance of a recording medium 11 and the operation of a carriage 8 (refer to FIG. 8), and forms an image on the recording medium 11.

FIG. 8 is illustrates a configuration of the recording apparatus 100. In the recording apparatus 100, ink tanks 1 that contain ink are mounted in a holder 2. FIG. 8 illustrates four ink tanks 1, but three or less or five or more ink tanks 1 can be used. The holder 2 is provided with a not-illustrated mounting detection unit, which detects at least one of the mounting of the ink tank 1 or the removal of the ink tank 1 by a user. Ink in the ink tanks 1 is supplied to a sub tank 7 via a tube 6, and is further supplied to the recording head 151 (not illustrated in FIG. 8). The supplied ink is ejected from the recording head 151 in response to a recording signal.

The recording head 151 and the sub tank 7 are mounted on the carriage 8 that reciprocally moves in a main-scanning directions in a guide rail 3. By repeatedly alternated scanning for recording and conveyance operations, an image is formed on the recording medium 11 in a stepwise manner. In the scanning for recording, ink is ejected from the recording head 151 to the recording medium 11 along with the movement of the carriage 8. In the conveyance operation, the recording medium 11 is conveyed in a sub-scanning direction by a rotation of a conveyance roller 9.

When maintenance processing is executed on the recording head 151, the carriage 8 moves the recording head 151 to a position facing a recovery unit 10. The recovery unit 10 is equipped with a cap for capping the ejection port surface of the recording head 151, and a decompression pump (not illustrated) is connected with the cap. The decompression pump is operated with the cap pressed against the ejection port surface of the recording head 151, forcibly ejects ink from a plurality of ejection ports, and removes bubbles, thickening ink, and foreign substances in the recording head 151.

The recording apparatus 100 includes a conveyance control unit 161 that controls the conveyance roller 9, and a carriage control unit 162 that controls the carriage 8. The conveyance control unit 161 and the carriage control unit 162 are connected with the system bus 132, and are controlled by the CPU 128. The conveyance control unit 161 feeds the recording medium 11 from a stacking unit or a holding unit, and conveys the recording medium 11 along with the movement of the carriage 8. In a case where the recording medium 11 is roll paper, it is possible to cut the recording medium 11 with a non-illustrated cutter after image formation is completed by the recording head 151. The recording medium 11 is not limited to roll paper, and can be cut paper that is preliminarily cut into a predetermined size. The carriage control unit 162 operates the carriage 8 in the main-scanning directions.

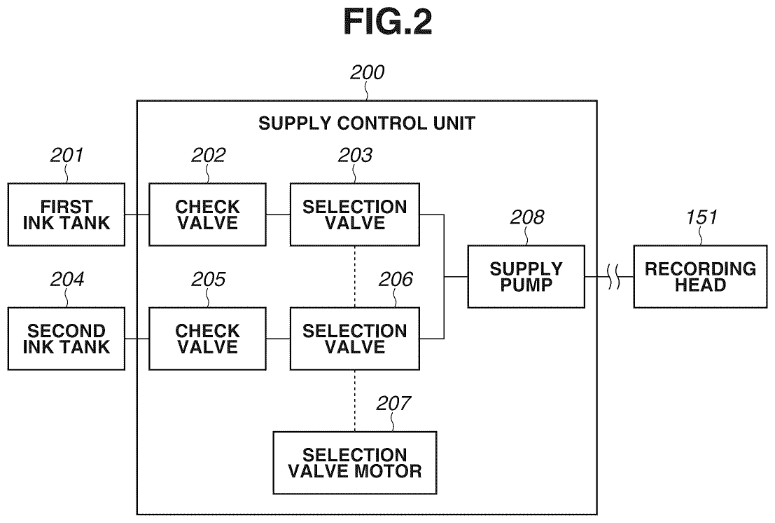

The recording apparatus 100 includes a supply control unit 200. The supply control unit 200 is connected to the system bus 132, and is controlled by the CPU 128 to supply ink from the ink tanks 1 detachable by a user to the recording head 151. A detailed configuration of the supply control unit 200 will be described with reference to FIG. 2.

FIG. 2 is a block diagram illustrating a configuration of the supply control unit 200 of the recording apparatus 100. A flow channel for supplying ink from the ink tanks 1 to the recording head 151 will be described with reference to FIG. 2. In FIG. 2, the bold lines connecting the constituent elements indicate ink flow channels, and the dotted lines indicate electrical connections. FIG. 2 illustrates the flow channels for ink in one color, but a similar configuration can be applied to liquid, such as ink in other colors and reactant.

A first ink tank 201 and a second ink tank 204 (also collectively referred to as the ink tanks 1) are filled with ink of an identical color, which have similar configurations to each other. In the present exemplary embodiment, a description is provided of a configuration in which the two ink tanks 1 of identical colors can be mounted on the recording apparatus 100. The configuration is not limited thereto, and three or more ink tanks 1 for an identical color can be mounted. The first ink tank 201 and the second ink tank 204 are detachably connected with the supply control unit 200 upstream of check valves 202 and 205, respectively.

The check valves 202 and 205 prevent reverse flow of ink to the first ink tank 201 and the second ink tank 204, respectively. Selection valves 203 and 206 are provided downstream of the check valves 202 and 205, respectively. Flow channels meet downstream of the selection valves 203 and 206. Opening/closing the selection valves 203 and 206 control the supply of ink from either the first ink tank 201 or the second ink tank 204.

The selection valves 203 and 206 are configured to be opened/closed by the control of a cam, and one of the selection valves 203 and 206 is closed when the other is opened. The cam is rotated by the driving of a selection valve motor 207. A supply pump 208 is provided downstream of the merged flow channels. When the supply pump 208 is operated, ink is supplied via an opened valve, i.e., the selection valve 203 or the selection valve 206. The operation of the supply pump 208 sends ink to the recording head 151.

Ink used in the recording apparatus 100 includes ink whose component, such as a coloring material, precipitates by being left for a long period of time. In this state, the ink supplied to the recording head 151 can prevent the image quality from being maintained in some cases. After the ink tanks 1 are detached from the holder 2, a user can shake the ink tanks 1 upside down, and left and right, or rotate the ink tanks 1 to reduce or eliminate the precipitation of the contained ink. Normally, the user performs agitation in such a way at predetermined intervals (24 hours, one week, etc.), so that the quality of images recorded by the recording apparatus 100 is maintained.

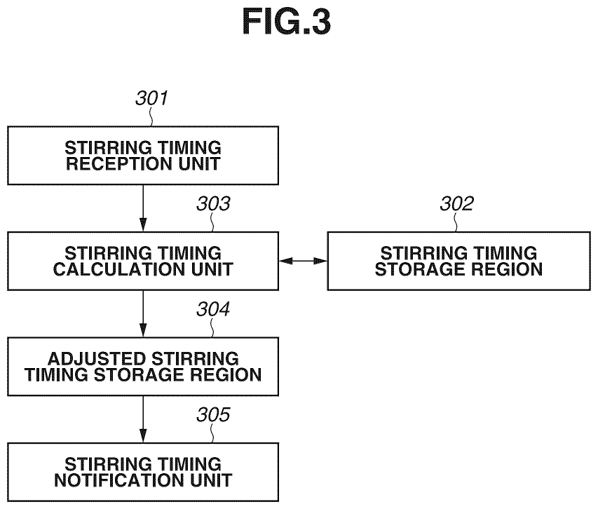

FIG. 3 is a block diagram illustrating the configuration of a control unit of the recording apparatus 100. A stirring timing reception unit 301 receives notifications about the mounting of the ink tanks 1 in the recording apparatus 100 or the completion of an agitation from the input/output unit 121 or the host computer 190. The stirring timing reception unit 301 receives the notifications in response to detections of the mounting of the ink tanks 1 by the mounting detection unit provided in the holder 2, or the user's operations of a stirring completion button via the input/output unit 121. A stirring timing storage region 302 is a storage medium for recording times and dates of agitating ink in the ink tanks 1. stopped

A stirring timing calculation unit 303 acquires the times and dates of agitating ink in the ink tanks 1 from the stirring timing storage region 302, calculates the next stirring timing, and records the calculated result in the stirring timing storage region 302. The stirring timing calculation unit 303 acquires the time and date when the next stirring is to be performed from the stirring timing storage region 302, and records the times and dates after adjusting the next stirring timing(s) for a plurality or all of the ink tanks 1 in an adjusted stirring timing storage region 304.

The stirring timing storage region 302 and the adjusted stirring timing storage region 304 are, for example, non-volatile storage mediums in the present exemplary embodiment, but in another exemplary embodiment can be volatile storage mediums. At the times and dates recorded in the adjusted stirring timing storage region 304, a stirring timing notification unit 305 provides notifications to the user via the input/output unit 121 of the recording apparatus 100 or the host computer 190.

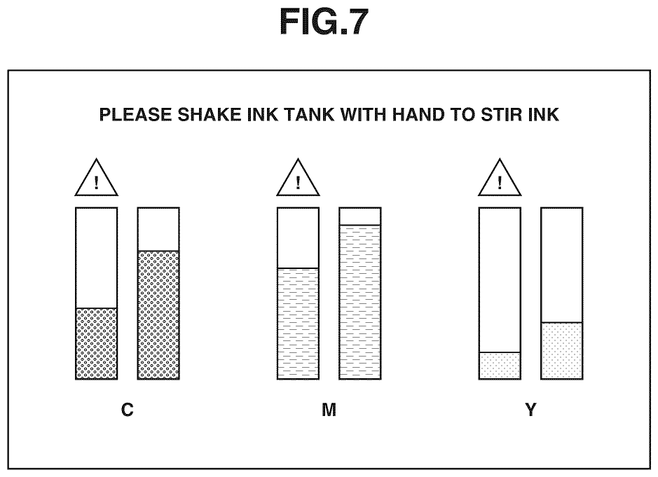

FIG. 7 is a diagram illustrating an example of a display screen output to the input/output unit 121. The recording apparatus 100 includes two ink tanks for each of the colors, cyan (C), magenta (M), and yellow (Y). In FIG. 7, the display screen indicates that ink in one of the two ink tanks for each of the three colors is to be agitated using a combination of graphics and texts. In the present exemplary embodiment, exclamation marks are added above the ink tanks 1 subject to an agitation to notify the user.

Notifications to the user are not limited to the display screen of the input/output unit 121 of the recording apparatus 100. Notifications can be provided on screens of mobile terminals via the host computer 190 or the network 191. A lamp (not illustrated) corresponding to each of the ink tanks 1 can be provided in the holder 2 in which the ink tanks 1 are mounted, and a notification about an agitation can be provided by lighting or blinking the lamp. Notifications can be performed to the user via an output, such as sound (buzzer sound, or voice). Notifications can be performed with a combination of two or more selected from among the screen display, the lighting or blinking of the lamp, or the output of sound.

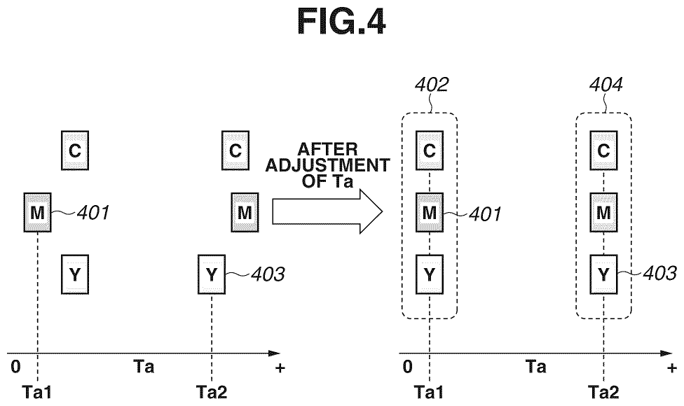

FIG. 4 illustrates processing of adjusting the next stirring timing after the recording apparatus 100 receives a notification about the completion of an agitation from the user. A value indicating the next stirring timing is Ta. Ta decreases with the elapse of time, and an agitation is performed at a timing when Ta becomes 0. FIG. 4 illustrates an image of the ink tanks 1 before an adjustment of Ta on the left, and illustrates an image of the ink tanks 1 after an adjustment of Ta on the right. Abscissa axes indicate the next stirring timings Ta. The processing illustrated in FIG. 4 is based on the assumption of the recording apparatus 100 in which two ink tanks 1 for each of the three colors, cyan (C), magenta (M), and yellow (Y) are mounted.

A group described below means an “ink tank group where the same Ta is set”.

The smallest Ta from among Ta values of all ink tanks 1 is referred to as Ta1. An ink tank 1 having Ta1 is referred to as T1, and T1 is indicated as rectangular element 401. In FIG. 4, T1 is the ink tank 1 for magenta. A group where T1 ink tanks after an adjustment of a Ta belong is indicated by dashed frame 402 as a first group (inside a dashed frame).

The smallest Ta from among Ta values of ink tanks 1 that do not belong to the first group is referred to as Ta2. An ink tank 1 having Ta2 is referred to as T2, and the T2 is indicated as rectangular element 403. In FIG. 4, T2 is the ink tank 1 for yellow. A group where T2 ink tanks after an adjustment of Ta belong is indicated by dashed frame 404 as a second group (inside a dashed frame).

The first group may be set as an “ink consumption group”. In other words, a group that supplies ink to the recording head 151. In a case where Ta1 is a predetermined threshold or more, a group including an ink tank 1 with the lowest remaining quantity may be set as the “ink consumption group”. In other words, the group that supplies ink to the recording head 151.

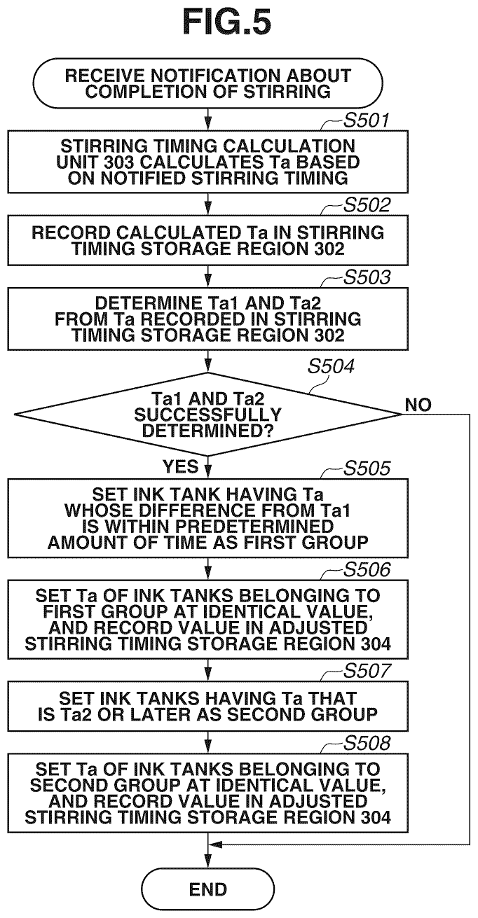

FIG. 5 is a flowchart illustrating processing of adjusting the next stirring timing for the mounted ink tanks 1. The flowchart in FIG. 5 illustrates a procedure when a group is set based on the next stirring timing. When the stirring timing reception unit 301 receives a notification about the completion of an agitation, the processing starts.

In steps S501, the stirring timing calculation unit 303 calculates the Ta of an ink tank 1 based on the time and date when the notification is received. In step S502, the calculated Ta is recorded in the stirring timing storage region 302. In step S503, the stirring timing calculation unit 303 determines the Ta1 and the Ta2 from the Ta recorded in the stirring timing storage region 302. A plurality of pieces of information about the Ta is used to achieve this. In determining the Ta2, the Ta of the ink tanks 1 that do not belong to the first group, in other words, the Ta of the ink tanks 1 in the second group is used.

In step S504, the stirring timing calculation unit 303 determines the Ta1 and the Ta2. if the determination of the Ta1 and the Ta2 is successful (YES in step S504), the processing proceeds to step S505. If the determination is not successful (NO in step S504), the processing ends. In step S505, the ink tanks 1 with Ta values whose difference from the Ta1 is within a predetermined amount of time are set as the first group in the stirring timing storage region 302. In step S506, the Ta values of the ink tanks 1 belonging to the first group are set to an identical value, and the value is recorded in the adjusted stirring timing storage region 304. The Ta values of the ink tanks 1 belonging to the first group may be uniformly set to the Ta1 or may be uniformly set to a value other than the Ta1.

In step S507, the ink tanks 1 with Ta values that are the Ta2 or more are set as the second group. In step S508, the Ta values of the ink tanks 1 belonging to the second group is set to an identical value. The value is recorded in the adjusted stirring timing storage region 304, and the processing ends. The Ta values of the ink tanks 1 belonging to the second group may be uniformly set to the Ta2, or may be uniformly set to a value other than the Ta2. Additionally, in step S507, control can be performed to set the ink tanks 1 other than the ink tanks 1 in the first group as the second group.

At the stirring timing for the first group after the above-described control, the stirring timing notification unit 305 notifies the user to agitate ink in the ink tanks 1 of a plurality of ink types (ink colors) belonging to the first group as illustrated in FIG. 7. Thus, the stirring timing notification unit 305 provides simultaneous notifications to instruct an agitation of ink in the ink tanks 1 for the plurality of ink types (ink colors). As a method of simultaneous notifications, for example, a notification to instruct an agitation of ink in the ink tanks of the plurality of ink types is displayed on one screen as illustrated in FIG. 7. Similarly, at the stirring timing for the second group, the stirring timing notification unit 305 provides simultaneous notifications to instruct an agitation of ink in the ink tanks 1 of a plurality of ink types (ink colors).

“Simultaneous” according to the present disclosure is not limited to a case of the exact same time. For example, it is sufficient as long as the stirring timing notification unit 305 displays an instruction to agitate ink in the ink tanks 1 of the plurality of colors on an identical display screen of the input/output unit 121, and a case where there is a difference in time for display is included. The difference in time is, for example, five seconds or less, and is desirably three seconds or less or one second or less.

The above-described processing makes it possible to collectively and simultaneously notify the user of information for instructing an agitation of ink in the plurality of ink tanks 1. This configuration enables the user to efficiently perform agitating operations on the ink tanks 1 as compared with a case where an instruction for an agitation is notified to a corresponding ink tank of the ink tanks. Thus, this improves the user's operability as compared with a case where the user is notified at every stirring timing for each ink tanks 1 to perform an agitating operation each time.

A second exemplary embodiment will now be described. In the second exemplary embodiment, processing of setting a group is performed based on a quantity of ink remaining in the ink tanks 1. A basic configuration of the recording apparatus 100 is similar to that of the first exemplary embodiment. The supply control unit 200 acquires the quantity of ink remaining in the ink tank 1 using a dot counting method of calculating the quantity of ink ejected from the recording head 151 and estimating the quantity of remaining ink, or a method of directly detecting presence/absence of ink in the ink tanks 1.

The method of directly detecting ink in the ink tanks 1, for example, includes a plurality of electrodes (not illustrated) provided in the ink tanks 1 in contact with a liquid surface of ink in the ink tanks 1 to detect the quantity of ink based on a voltage when current flows between two electrodes. Presence/absence of ink can be detected by an optical detection method of emitting light internal to the ink tanks 1 to detect the presence/absence of ink, and a detection method of locating a floating member that floats on a liquid surface. A detection method can be used that combines the method of directly detecting presence/absence of ink and the detection method using estimation based on the dot counting method.

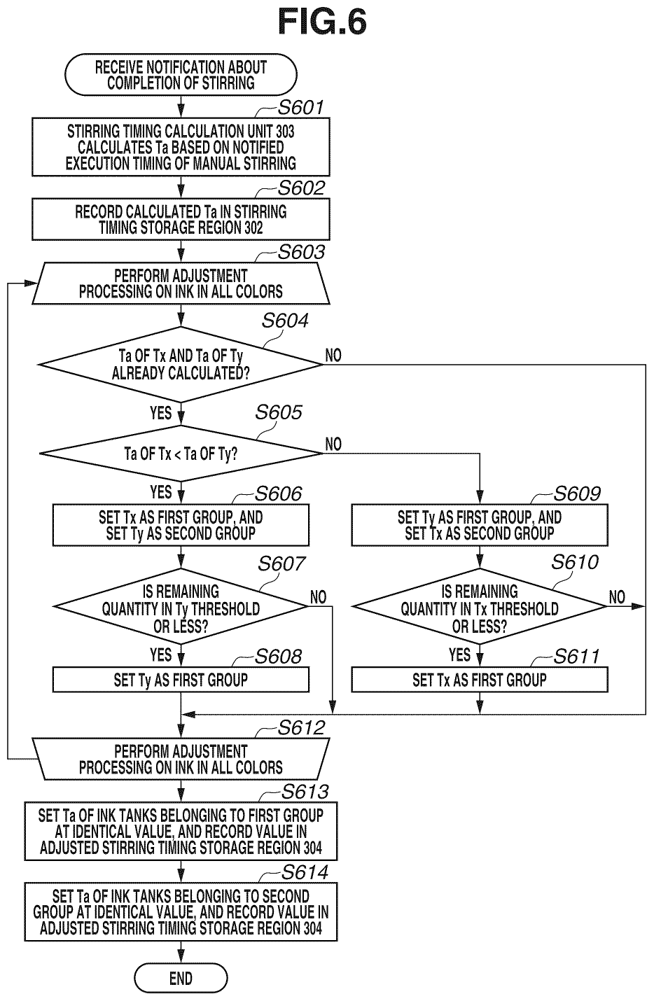

FIG. 6 is a flowchart when a group is set based on the next stirring timing and the quantity of ink remaining in the ink tanks 1. Two ink tanks 1 for each of the colors are mountable in the recording apparatus 100. One of the ink tanks 1 that contain ink in an identical color is Tx, and the other is Ty. When the stirring timing reception unit 301 receives a notification about the completion of an agitation, the processing starts.

In step S601, the stirring timing calculation unit 303 calculates Ta values of the ink tanks 1 based on the time and date when the notification is received. In step S602, the calculated Ta values are recorded in the stirring timing storage region 302.

In step S604, the stirring timing calculation unit 303 determines the Ta of the Tx and the Ta of the Ty. If both the Ta of the Tx and the Ta of the Ty are calculated (YES in step S604), the processing proceeds to step S605. If they are not calculated (NO in step S604), the processing proceeds to step S612. In step S605, the stirring timing calculation unit 303 determines whether the Ta of the Tx is smaller than the Ta of the Ty. If the Ta of the Tx is smaller than the Ta of the Ty (YES in step S605), the processing proceeds to step S606. If the Ta of the Tx is not smaller (NO in step S605), the processing proceeds to S609.

When the processing proceeds to step S606, the Tx is set as the first group, and the Ty is set as the second group. In step S607, the stirring timing calculation unit 303 determines whether a remaining quantity in the Ty is a threshold or less. If the remaining quantity in the Ty is the threshold or less (YES in step S607), the processing proceeds to step S608. If the remaining quantity in the Ty is not the threshold or less (NO in step S607), the processing proceeds to step S612. In step S608, the Ty is also set as the first group.

In a case where the processing proceeds to step S609, Ty is set as the first group, and the Tx is set as the second group. In step S610, the stirring timing calculation unit 303 determines whether the remaining quantity in the Tx is the threshold or less. In a case where the remaining quantity in the Tx is the threshold or less (YES in step S610), the processing proceeds to step S611. In a case where the remaining quantity in the Tx is not the threshold or less (NO in step S610), the processing proceeds to step S612. In step S611, the Tx is also set as the first group.

In the stirring timing storage region 302, the adjustment processing from steps S603 to S612 is performed on ink in all colors in the ink tanks 1, which are mounted in the recording apparatus 100. In step S613, in the stirring timing storage region 302, the Ta values of the ink tanks 1 belonging to the first group is set to an identical value and the value is recorded in the adjusted stirring timing storage region 304. Ta values of the ink tanks 1 belonging to the first group may be uniformly set to Ta1, or may be uniformly set to a value other than Ta1.

In step S614, the Ta values of the ink tanks 1 belonging to the second group is set to an identical value, and the value is recorded in the adjusted stirring timing storage region 304. Ta values of the ink tanks 1 belonging to the second group may be uniformly set to Ta2, or may be uniformly set to a value other than Ta2.

At the stirring timing for the first group after the above-described control, the stirring timing notification unit 305 notifies a user to agitate ink in the ink tanks 1 for a plurality of ink types (ink colors) belonging to the first group as illustrated in FIG. 7. Similarly, at the stirring timing for the second group, the stirring timing notification unit 305 provides simultaneous notifications to instruct an agitation of ink in the ink tanks 1 for a plurality of ink types (ink colors).

The above-described processing enables the user to efficiently perform an agitating operation on the ink in the ink tanks 1 as compared with a case where an instruction for an agitation is notified to a corresponding ink tank of the ink tanks. Thus, this improves the user's operability as compared with a case where the user is notified at every stirring timing for each ink tank 1 and performs an agitating operation each time.

In the above-described exemplary embodiments, the description has been provided of a serial printer in which the recording head 151 is mounted on the carriage 8 and performs recording while moving, but the present disclosure is not limited thereto. The present disclosure can be adopted in a printer that includes an ejection port having a length corresponding to the width of the recording medium 11, and performs recording using a line head without moving.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-035180, filed Mar. 7, 2024, which is hereby incorporated by reference herein in its entirety.

What is claimed is:

1. A recording apparatus comprising:
a holder including a plurality of tanks configured to contain liquid;
a recording head configured to eject the liquid supplied from the plurality of tanks; and
a control unit configured to provide a notification about an instruction for agitating the liquid in two or more tanks of the plurality of tanks.

2. The recording apparatus according to claim 1, the control unit further configured to:
calculate a stirring timing for each of the plurality of tanks,
provide, in a case where a difference between a first stirring timing for a first tank of the plurality of tanks and a second stirring timing for a second tank of the plurality of tanks is a first time, the notification about an instruction for agitating the liquid in the first tank and an instruction for agitating the liquid in the second tank, and
in a case where the difference between the first stirring timing and the second stirring timing is a second time greater than the first time, not provide the notification about the instruction for agitating the liquid in the first tank and notification about the instruction for agitating the liquid in the second tank.

3. The recording apparatus according to claim 2, the control unit further configured to, in a case where the difference is the first time and the first stirring timing is smaller than the second stirring timing, provide the notification about the instruction for agitating the liquid in the first tank and the instruction for agitating the liquid in the second tank at the first stirring timing.

4. The recording apparatus according to claim 2, wherein
the plurality of tanks includes a third tank and a fourth tank each configured to contain a first liquid, and
the control unit is further configured to, in a case where a fourth stirring timing for the fourth tank is smaller than a third stirring timing for the third tank, supply the first liquid from the fourth tank to the recording head.

5. The recording apparatus according to claim 4, the control unit further configured to:
acquire a remaining quantity of the liquid in each of the plurality of tanks,
supply, in a case where a third remaining quantity in the third tank is less than a fourth remaining quantity in the fourth tank and the fourth stirring timing is a third time, the liquid from the fourth tank to the recording head, and
supply, in a case where the third remaining quantity is less than the fourth remaining quantity and the fourth stirring timing is a fourth time greater than the third time, the liquid from the third tank to the recording head.

6. The recording apparatus according to claim 1, further comprising a display unit configured to display the instruction.

7. The recording apparatus according to claim 1, wherein the control unit is further configured to provide the notification by controlling the lighting status of a lamp.

8. The recording apparatus according to claim 1, wherein the control unit is further configured to provide the notification by outputting sound.

9. A method for a recording apparatus that includes a holder including a plurality of tanks configured to contain liquid and a recording head that ejects the liquid supplied from the plurality of tanks, the method comprising:
providing a notification about an instruction for agitating the liquid in two or more tanks of the plurality of tanks.
